(19) United States
(12) Patent Application Publication
(10) Pub. No.: US 2026/0195578 A1
(43) Pub. Date: Jul. 9, 2026

(54) SYSTEMS AND METHODS FOR DYNAMIC NEURAL NETWORK CONDITIONING

(71) Applicant: Roadhouse, Inc., Wilmington, DE (US)

(72) Inventors: Ian Segal, Walnut Creek, CA (US); Eric Karl, Walnut Creek, CA (US)

(73) Assignee: Roadhouse, Inc., Wilmington, DE (US)

(21) Appl. No.: 19/441,388

(22) Filed: Jan. 6, 2026

Related U.S. Application Data
(60) Provisional application No. 63/742,272, filed on Jan. 6, 2025.

(51) Int. Cl. G06N 3/0495

(52) U.S. Cl. CPC G06N 3/0495

(57) ABSTRACT

A computer-implemented method of dynamically conditioning a neural network. The method includes receiving a target signal and processing the target signal with an encoder to obtain a conditioning embedding based on the target signal. The method includes receiving an input signal to be processed. Based on the conditioning embedding and a set of learned parameters, the method includes computing one or more style-conditioned parameters for one or more layers of a base neural network. The method includes applying the base neural network to the input signal using the style-conditioned parameters to generate a modeled output signal.

### CROSS-REFERENCE TO RELATED APPLICATIONS

This application claims priority to U.S. Provisional Application No. 63/742,272, filed Jan. 6, 2025, the disclosure of which is incorporated by reference herein in its entirety.

### TECHNICAL FIELD

The present disclosure relates to conditioning neural networks and, more particularly, to conditioning neural networks using hypernetworks.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

In the context of machine learning, artificial intelligence (AI) and training AI models, conditioning may involve using external information or context to influence the behavior or output of an AI model. Conditioning may involve guiding a model to generate outputs based on specific inputs or conditions, and may be useful to produce data that meets certain criteria or follows a particular pattern. Style transfer is a subset of conditioning in which the style of one input (e.g., an image, audio clip, etc.) may be transferred to another input (like another image or signal). In other words, style transfer may involve blending the “style” of a first media input with the content of a second media input, generating a new version of the second media input in the style of the first as an output. In style transfer, the “style” may be the conditioning vector that influences how the model's output may be generated or modified. Traditionally, real-time or substantially real-time style transfer has been elusive.

Further, replicating or creating instrumental effects required extensive knowledge of the instrument, the recording environment, electronics, etc. For example, achieving the distinctive reverb of a grand piano in a concert hall or the distortion of an electric guitar through a tube amplifier could require meticulous setup, expensive equipment, and extensive trial and error. More recently, however, digital technology has improved access to these sounds, allowing even amateur musicians to produce high-quality music from their home studios. Despite these advancements, accurately replicating the nuanced effects or styles of certain instruments, artists, and sounds remains a challenge, and may still require expensive, specialized equipment (e.g., digital amplifiers, effects pedals, etc.).

Finally, hypernetworks are neural networks in which a separate network may predict some or all of the parameters of a target network, and may be used for conditioning or modulating models. However, while hypernetwork-based methods may generate task specific or input specific weights, they are computationally expensive, especially when predicting full rank weight matrices for each layer of a large model. Further, parameter-efficient fine tuning (PEFT) methods, such as low rank adapters (LoRA), may be used to adapt large, pre-trained models to new tasks using a relatively small number of additional parameters. In LoRA approaches, weight updates are expressed as low rank matrices that are added to frozen base weights during fine tuning. While effective, such methods typically assume an offline adaptation process for each new task or style and do not directly address sample by sample real time conditioning of streaming signals.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a superpositional decoder in which style or conditioning information may be passed into a neural net as an extra dimension in some or all of its weights and biases. In some embodiments, the computational complexity of the superpositional decoder during inference and deployment may be negligible. In some embodiments, the implementation model may involve passing a desired style in the form of a recording, live sample, or other target signal into a custom encoder, extracting a conditioning vector or vectorized embeddings, and passing that conditioning vector into the superpositional decoder along with a raw input signal. The superpositional decoder may be used in a variety of contexts, including modeling musical instrument sounds and effects in substantially real time, modeling spoken audio, image frames, video, sensor data, or other time series or spatial data.

In another embodiment, the disclosure describes a computer-implemented method of dynamically conditioning a neural network. The method may include receiving, by one or more processors, a target signal and processing, by the one or more processors, the target signal with an encoder to obtain a conditioning embedding based on the target signal. The method may include receiving, by the one or more processors, an input signal to be processed. Based on the conditioning embedding and a set of learned parameters, the method may include computing, by the one or more processors, one or more style-conditioned parameters for one or more layers of a base neural network. The method may include applying, by the one or more processors, the base neural network to the input signal using the style-conditioned parameters to generate a modeled output signal.

In another embodiment, the disclosure describes a system for dynamically conditioning a neural network. The system may include one or more dynamic conditioning servers connected to a communications network. The one or more servers may include one or more server processors and a server memory containing processor-executable instructions that, when executed by the one or more server processors, cause the one or more dynamic conditioning servers to receive a target signal, and process the target signal with an encoder to obtain a conditioning embedding based on the target signal. The system may include a computing device in communication with the one or more dynamic conditioning servers via the communications network. The computing device may include one or more device processors and a device memory containing processor-executable instructions that, when executed by the one or more device processors, cause the computing device to receive the conditioning embedding from the one or more servers via the communication network and receive an input signal to be processed. Based on the conditioning embedding and a set of learned parameters, the computing device may compute one or more style-conditioned parameters for one or more layers of a base neural network and apply the base neural network to the input signal using the style-conditioned parameters to generate a modeled output signal.

In another embodiment, the disclosure describes a computer-implemented method of dynamically conditioning a neural network. The method may include receiving, by one or more processors, a target signal corresponding to a target style. The method may include processing, by the one or more processors, the target signal with an encoder to obtain a conditioning embedding based on the target signal. The method may include receiving, by the one or more processors, an input signal to be processed. Based on the conditioning embedding and a set of learned parameters, the method may include computing, by the one or more processors, one or more style-conditioned parameters for one or more layers of a base neural network. The style-conditioned parameters for each layer of the one or more layers of the base neural network may include a base weight matrix and a weight update combined with the base weight matrix to produce an effective style-conditioned weight matrix. The method may include storing, in a memory, the style-conditioned weight matrices for each layer of the one or more layers of the base neural network. The method may include applying, by the one or more processors, the base neural network using the stored style-conditioned weight matrices without recomputing the weight update to the input signal to generate a modeled output signal.

### BRIEF DESCRIPTION OF THE DRAWINGS

The appended claims set forth with particularity certain novel features that are considered characteristic of one or more embodiments of the present disclosure. The embodiments of the disclosure itself; however, both as to its structure and operation together with the additional objects and advantages thereof are best understood through the following description when read in conjunction with the accompanying drawings. The components in the figures are not necessarily to scale, emphasis instead being placed upon illustrating the principles of the disclosure. In the figures, like reference numerals designate corresponding parts throughout the different views, wherein:

FIG. 1 is a flow chart showing an embodiment of using a system for dynamic neural network conditioning as shown and described herein;

FIG. 2 is a symbolic diagram of a simplified hardware environment for using the system for dynamic neural network conditioning of FIG. 1;

FIG. 3 is a schematic illustration of elements of an embodiment of an example computing device;

FIG. 4 is a schematic illustration of elements of an embodiment of a server type computing device;

FIG. 5A shows an example waveform of an input signal in accordance with the disclosure;

FIG. 5B shows an example waveform of a target signal in accordance with the disclosure;

FIG. 5C shows an example waveform of a predicted signal based on the input signal of FIG. 5A and the target signal of FIG. 5B;

FIG. 6A shows an example waveform of an input signal in accordance with the disclosure;

FIG. 6B shows an example waveform of a target signal in accordance with the disclosure;

FIG. 6C shows an example waveform of a predicted signal based on the input signal of FIG. 6A and the target signal of FIG. 6B; and

FIG. 7 shows example waveforms related to another embodiment of the system of FIG. 1.

Persons of ordinary skill in the art will appreciate that elements in the figures are illustrated for simplicity and clarity so not all connections and options have been shown to avoid obscuring various aspects of the disclosure. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. These illustrations and exemplary embodiments are presented with the understanding that the description and figures are an exemplification of the principles of one or more embodiments of the disclosure. The disclosure may be embodied in many different forms and should not be construed as limited to the embodiments set forth herein; rather, these embodiments are provided so that this disclosure will be thorough and complete, and will fully convey the scope of the disclosure to those skilled in the art. Among other things, the present disclosure may be embodied as methods or devices. The following detailed description is, therefore, not to be taken in a limiting sense.

Throughout the disclosure and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The figures depict embodiments for purposes of illustration only. One skilled in the art will readily recognize from the following discussion that alternative embodiments of the structures and methods illustrated herein may be employed without departing from the principles described herein.

In some embodiments, the disclosure describes systems and methods for dynamic neural network conditioning. The system may have beneficial uses in a variety of applications, such as in providing for substantially real-time signal conditioning, conditioning in images, video, AR/VR signals, other telecommunications signals, etc. For example, some applications may include an electric guitar signal, spoken audio, image frames, video, sensor data, or other time series or spatial data. In some embodiments, the system may perform highly dynamic conditioning on the model which, once in inference or deployment, may still be computationally lightweight while producing outputs that improve results provided with traditional mechanisms. The system and methods may create opportunities to improve the quality of many existing technologies and to lower the cost of others, while also opening new fields of inquiry and innovation.

As described in detail herein, the disclosed superpositional way of constructing neural networks may, in some embodiments, change the network's architecture, the way their parameters train, what patterns their parameters “learn,” how the patterns manifest, and how information is both stored and moves through them. Traditional conditioning in machine learning may include using fixed weights and biases whose mappings get transformed by affine transformations or may concatenate style information to the input, etc. In some embodiments, the disclosed systems and methods may create completely custom models suited to each unique style vector or vectorized embeddings while remaining computationally indistinguishable from simpler, classic models during inference and deployment. Accordingly, the disclosed systems and methods may allow generalizable models to be built that may recombine themselves automatically for each unique conditioning and may provide benefits in any domain space where real-time conditioning of a signal (or static data into a neural network) may be additive/extrapolated/exploited. By embedding the style information directly into the weights and biases during training and then “collapsing” these into a classic architecture for deployment, the systems and methods described herein may provide a versatile and scalable solution that may be tailored to a wide range of applications, from real-time audio processing, audio and visual super-resolution, to adaptive AI in telecommunications. Some non-limiting example applications may include an electric guitar signal, spoken audio, image frames, video, sensor data, or other time series or spatial data.

In the context of artificial intelligence (AI) and training AI models, conditioning may involve using external information or context to influence the behavior or output of an AI model. Conditioning may involve guiding a model to generate outputs based on specific inputs or conditions, and may be useful to produce data that meets certain criteria or follows a particular pattern. Traditionally, conditioning may be achieved by methods such as concatenating additional input vectors, modulating internal model parameters, or adjusting feature maps based on conditioning information. A conditioning vector may be a set of additional information or features used to guide the generation process, and may provide context or conditions that the model uses to produce specific outputs. Conditioning may be used in various applications, including conditional generative models (e.g., Conditional Generative Adversarial Networks (GANs)), sequence-to-sequence models, and multimodal models where one modality conditions the output in another.

Style transfer is a subset of conditioning in which the style of one input (e.g., an image, audio clip, etc.) may be transferred to another input (like another image or signal). In other words, style transfer may involve blending the “style” of a first media input with the content of a second media input, generating a new version of the second media input in the style of the first as an output. In style transfer, the “style” may be the conditioning vector that influences how the model's output may be generated or modified. Style transfer may be used in a variety of contexts, such as art and design, photo and video editing, virtual reality, augmented reality, musical composition, etc.

Traditionally, real-time or substantially real-time style transfer has been elusive. Real-time style transfer may be particularly helpful for signals where their temporal nature may create a meaningful distinction between whether the conditioning is being applied in real-time or post-hoc. One such example domain for conditioning in signals is the electric guitar effects space. With electric guitar effects, the modulations made to a reference signal may be highly complex and non-linear. Traditionally, it has been difficult to model highly complex guitar signal chains (e.g., effects like reverb and delay) because those signals may stretch dependencies across very large volumes of data and their interdependence may be exceptionally complex to model. Often, systems may not be useful because: (1) custom hardware may be very expensive and not available to everybody, and/or (2) even that custom hardware tends to be limited in what sorts of signal chains it can emulate.

In some embodiments, the systems and methods for dynamic neural network conditioning described herein may provide for modeling, in substantially real-time, complex chains of effects for many/unlimited unique signal chains within a single generalizable model. Those skilled in the art will recognize that the system and methods described may be applied in myriad fields, particularly those where signal conditioning in real-time can be salutary to existing technology. For example, the system may be useful in enhancing fidelity of telecommunications, providing less expensive and better solutions to customers in various fields, such as providing a “universal guitar amp” that may be significantly more accessible and less expensive than the physical gear it would replace.

In some fields, such as telecommunications and algorithmic trading, a need exists for real-time style conditioning to enhance clarity and fidelity of transmitted signals. Those skilled in the art will recognize other fields where the described systems and methods may be beneficial, particularly those where signal fidelity and processing speed may be important, including but not limited to conditioning spoken audio, image frames, video, sensor data, or other time series or spatial data.

In some embodiments, the systems and methods for dynamic neural network conditioning described herein may include an algorithmic technique for passing information in the form of a vector (i.e., conditioning vector) into a neural network composed of weights and biases using a novel methodology/architecture for the neural network itself. The systems and methods may also include a custom model using this algorithmic technique, in which a customized encoder may pass relevant style information to a decoder (i.e., superpositional decoder) that may use the algorithm to perform functionally real-time style conditioning on a separate raw input signal. In some embodiments, the custom model may be implemented in many applications, such on an electric guitar signal as a “universal guitar signal chain emulator,” telecommunications, spoken audio, image frames, video, sensor data, or other time series or spatial data and signal processing. Those skilled in the art will recognize that the applications of the methods described herein may be virtually unlimited.

Existing hypernetwork and LoRA approaches typically do not explicitly support collapsing dynamically generated parameters into compact, per style models suitable for deployment in resource constrained or real-time environments. Additionally, such methods typically assume an offline adaptation process for each new task or style and may not directly address sample-by-sample real-time conditioning of streaming signals. In contrast, the style conditioned low rank adapters disclosed herein may be layered on top of, or composed with, other parameter-efficient fine-tuning (PEFT) schemes (prefix tuning, adapters, etc.), but may be specialized for per-sample or per-style real-time changes rather than one-time fine tuning.

Accordingly,; among other things, the systems and methods described herein may provide solutions such as: 1) improved modeling of long temporal, non-linear complexities and interdependencies in signals; 2) reducing computational overhead for performing that conditioning; 3) making real-time complex signal conditioning and style transfer accessible on myriad devices, including mobile devices, without relying on cloud computing; 4) creating dynamic and adaptable models than traditionally available; 5) developing more dynamic and adaptable models with negligible computational cost during inference and deployment; and 6) allowing for ‘differentiable’ human input/feedback in the training and inference process. In some embodiments, the disclosure may provide for relatively large models that may be capable of modeling highly variable and complex domains, but that may be built and deployed with much lighter computational footprints than may be traditionally used, and without having to train any “student” or intermediate models.

In some embodiments, the system may include using an encoder-decoder model, in which an encoder may process input data into an encoded format that may be used by the model, and a decoder may transform the encoded data into an output. The encoded format may be a compressed representation of the input (e.g., a compact, numerical representation of the input) that may capture essential features and/or patterns of the input. The encoder may transform the input into a fixed-size vector or set of vectors that may represent the input, as described in further detail below.

In some embodiments, the system may include passing a desired style in the form of a style input or target input into an encoder. The target input may be virtually any input with a style sought to be replicated, such as a voice recording, music or instrument recording, live sample of a desired tone, etc. For example, the target input may be an example of a particular effect produced by an electric guitar or other instrument in a song or other recording, a voice sample, sample image, etc. In some embodiments, the system may include extracting a style vector and/or vectorized embeddings from the target input, where the style vector may be a numerical representation of the target input's “style” in the form of vectorized embeddings. As used herein, a “style vector,” “style key,” “style embedding” or more generally a “conditioning embedding” may be a learned vector that may parameterize how the base model may be modulated for a given style, speaker, task, or other condition. A conditioning embedding may be computed from a target or reference signal and may then be used to alter, in a task dependent way, the effective weights, biases, and/or intermediate activations of a base model that processes a raw input signal. Further, in some embodiments, the base model may be an autoregressive model, a recurrent neural network, a convolutional network, a transformer, a diffusion model, or any other neural architecture. A raw input signal to be transformed in the same style may be received, such as an electric guitar signal, spoken audio signal, image frames, video signal, or other time-series or spatial data, although the raw input signal may be virtually any signal sought to be amended to replicate the style of the target input, such as an instrument input, a digital telephone call, a video call, an image, etc.

The style vector may then be passed into a superpositional decoder along with a raw input signal. In some embodiments, the superpositional decoder in which style or conditioning information may be passed into a neural network may be an extra dimension in its weights and biases but may have substantially negligible computational complexity during inference and deployment. Some example neural network architectures include, but are not limited to, recurrent neural networks (RNN), long short-term memory (LSTM), convolutional neural network (CNN), gated recurrent unit (GRU), transformer, GAN, etc. In some embodiments, the weights and biases of a “classic” model may be given an extra dimension into which the style information (in the form of the style vector) may be passed. For the purposes of training, this may essentially expand the parameter size of the decoder by an extra dimension that may be the size of the style vector. When the style vector may then be passed into the decoder, it may be applied via matrix multiplication which may, in effect, “collapse” the extra dimension and create a custom slice of “classically dimensioned weights and biases” that are unique to the given style. Accordingly, the superpositional decoder may include an extra dimension to some or all of the weights and biases of a given neural network architecture into which style information is passed as a vector.

In other words, the base model may include superpositional layers that may conceptually add an extra conditioning dimension to the weights and/or biases. During inference, the conditioning embedding may be applied to this extra dimension via tensor operations/matrix multiplications, yielding effective “collapsed” weights and biases that may be mathematically equivalent to a dedicated “per style” model but that may be generated on-the-fly. In some embodiments, these superpositional layers may be implemented using parameter efficient low rank adapters. For example, in some embodiments, a style conditioned linear layer may include a shared base weight matrix and a set of low rank update matrices whose coefficients may be generated from the conditioning embedding by a lightweight hypernetwork. This implementation may be related to, but distinct from, conventional Low Rank Adaptation (LoRA) methods used for fine tuning large language models, and may enable real time, per-sample adaptation with significantly reduced parameter counts and memory usage compared to storing a full set of weights for each style or task.

As a non-limiting example, in some embodiments, the system may implement a custom LSTM as a superpositional LSTM. Those skilled in the art will appreciate that virtually any model capable of incorporating the conditioning embeddings may be used, such as CNNs, transformers, U-Nets, diffusion, etc.. Traditionally, LSTMs may include weights and biases. The weights may be:
1) Input-to-Hidden Weights (W_ih): A 2D matrix with dimensions (input_size, hidden_size*4). Input-to-hidden weights may determine how much influence each input feature may have on the neurons in the hidden layer. The input size may be the number of features or dimensions in the input data and may determine how many input neurons the network may have in the input layer. The hidden size may be the number of neurons in a hidden layer of the network. The *4 may account for the four different gate operations of the LSTM (input gate, forget gate, cell gate, output gate).
Weight IH (Shape: 4×16):
[[w_ih11, w_ih12, w_ih13, . . . , w_ih116]
[w_ih21, w_ih22, w_ih23, . . . , w_ih216]
[w_ih31, w_ih32, w_ih33, . . . , w_ih316]
[w_ih41, w_ih42, w_ih43, . . . , w_ih416]]

The input gate and the forget gate may help the LSTM maintain relevant information over long sequences. The input gate may selectively allow new information into the cell state by controlling which portions of the input may be added to the cell state. The forget gate may help the LSTM forget irrelevant or outdated information by determining which information from the previous cell state may be discarded. The output gate may help ensure that only relevant information may be passed on to the next layer or time step by controlling flow of information from the cell state to the hidden state at each time step. Each gate may use a non-linear activation function to produce values between 0 and 1 as weights (0=low weight (discard), 1=high weight (retain)).
2) Hidden-to-Hidden Weights (W_hh): A 2D matrix with dimensions (hidden_size, hidden_size*4). Hidden-to-hidden weights may determine how the hidden state from a previous time step influences the hidden state of the current time step. Each row may correspond to the weights connected to one of the four gates:
Weight HH (Shape: 4×16):
[[w_hh11, w_hh12, w_hh13, . . . , w_hh116]
[w_hh21, w_hh22, w_hh23, . . . , w_hh216]
[w_hh31, w_hh32, w_hh33, . . . , w_hh316]
[w_hh41, w_hh42, w_hh43, . . . , w_hh416]]

The biases may be Input Biases (b_ih) and Hidden Biases (b_hh): Both may be 1D vectors with dimensions (hidden_size*4). Each part of the vector may correspond to one of the gates in the LSTM:
Bias IH (Shape: 16):
[b_ih1, b_ih2, b_ih3, . . . , b_ih16]
Bias HH (Shape: 16):
[b_hh1, b_hh2, b_hh3, . . . , b_hh16]

In some embodiments, in embodiments using an LSTM, the superpositional LSTM may have the following architecture in its initial layer. In some embodiments, only one (or more) “superpositional” layers may be used, though standard layers may follow, precede, or be interspersed with:
1) Input-to-Hidden Weights (W_ih): This may be a 3D tensor with dimensions (style_vector_size, input_size, hidden_size*4). The additional dimension (style_vector_size) allows for style modulation.
2) Hidden-to-Hidden Weights (W_hh): This is also expanded to a 3D tensor with dimensions (style_vector_size, hidden_size, hidden_size*4).

Biases (b_ih and b_hh): In the Superpositional LSTM, these biases may become 2D tensors with dimensions (style_vector_size, hidden_size*4). Each slice along the style_vector_size dimension may correspond to a different set of biases modulated by the style information passed into the decoder.

In one example, the style vector (i.e., conditioning vector and/or conditioning embedding) may have a size of 4:
[s1, s2, s3, s4].

In such an example, the superpositional LSTM weights and biases (from traditional LSTM above) with the extra style vector dimension may be the following:

Superpositional LSTM Input-to-Hidden Weight (Weight IH (Shape: 4×4×16)):
[[[w_ih111, w_ih112, w_ih113, . . . , w_ih1116],
[w_ih121, w_ih122, w_ih123, . . . , w_ih1216],
[w_ih131, w_ih132, w_ih133, . . . , w_ih1316],
[w_ih141, w_ih142, w_ih143, . . . , w_ih1416]],
[[w_ih211, w_ih212, w_ih213, . . . , w_ih2116],
[w_ih221, w_ih222, w_ih223, . . . , w_ih2216],
[w_ih231, w_ih232, w_ih233, . . . , w_ih2316],
[w_ih241, w_ih242, w_ih243, . . . , w_ih2416]],
[[w_ih311, w_ih312, w_ih313, . . . , w_ih3116],
[w_ih321, w_ih322, w_ih323, . . . , w_ih3216],
[w_ih331, w_ih332, w_ih333, . . . , w_ih3316],
[w_ih341, w_ih342, w_ih343, . . . , w_ih3416]],
[[w_ih411, w_ih412, w_ih413, . . . , w_ih4116],
[w_ih421, w_ih422, w_ih423, . . . , w_ih4216],
[w_ih431, w_ih432, w_ih433, . . . , w_ih4316],
[w_ih441, w_ih442, w_ih443, . . . , w_ih4416]]].

Superpositional LSTM Hidden-toHidden Weight (Weight HH (Shape: 4×4×16)):
[[[w_hh111, w_hh112, w_hh113, . . . , w_hh1116],
[w_hh121, w_hh122, w_hh123, . . . , w_hh1216],
[w_hh131, w_hh132, w_hh133, . . . , w_hh1316],
[w_hh141, w_hh142, w_hh143, . . . , w_hh1416]],
[[w_hh211, w_hh212, w_hh213, . . . , w_hh2116],
[w_hh221, w_hh222, w_hh223, . . . , w_hh2216],
[w_hh231, w_hh232, w_hh233, . . . , w_hh2316],
[w_hh241, w_hh242, w_hh243, . . . , w_hh2416]],
[[w_hh311, w_hh312, w_hh313, . . . , w_hh3116],
[w_hh321, w_hh322, w_hh323, . . . , w_hh3216],
[w_hh331, w_hh332, w_hh333, . . . , w_hh3316],
[w_hh341, w_hh342, w_hh343, . . . , w_hh3416]],
[[w_hh411, w_hh412, w_hh413, . . . , w_hh4116],
[w_hh421, w_hh422, w_hh423, . . . , w_hh4216],
[w_hh431, w_hh432, w_hh433, . . . , w_hh4316],
[w_hh441, w_hh442, w_hh443, . . . , w_hh4416]]].

Superpositional LSTM Input-to-Hidden Bias (Bias IH (Shape: 4×16)):
[[b_ih11, b_ih12, b_ih13, . . . , b_ih116],
[b_ih21, b_ih22, b_ih23, . . . , b_ih216],
[b_ih31, b_ih32, b_ih33, . . . , b_ih316],
[b_ih41, b_ih42, b_ih43, . . . , b_ih416]]

Superpositional LSTM Hidden-to-Hidden Bias (Bias HH (Shape: 4×16)):
[[b_hh11, b_hh12, b_hh13, . . . , b_hh116],
[b_hh21, b_hh22, b_hh23, . . . , b_hh216],
[b_hh31, b_hh32, b_hh33, . . . , b_hh316],
[b_hh41, b_hh42, b_hh43, . . . , b_hh416]].

When multiplied by the style vector, the extra dimensions collapse, resulting in “classically” shaped weights and biases that have incorporated the style vector (i.e., “style-modulated”):
Modulated Weight IH (Shape: 4×16):
[[w_mod_ih11, w_mod_ih12, w_mod_ih13, . . . , w_mod_ih116],
[w_mod_ih21, w_mod_ih22, w_mod_ih23, . . . , w_mod_ih216],
[w_mod_ih31, w_mod_ih32, w_mod_ih33, . . . , w_mod_ih316],
[w_mod_ih41, w_mod_ih42, w_mod_ih43, . . . , w_mod_ih416]]
Modulated Weight HH (Shape: 4×16):
[[w_mod_hh11, w_mod_hh12, w_mod_hh13, . . . , w_mod_hh116],
[w_mod_hh21, w_mod_hh22, w_mod_hh23, . . . , w_mod_hh216],
[w_mod_hh31, w_mod_hh32, w_mod_hh33, . . . , w_mod_hh316],
[w_mod_hh41, w_mod_hh42, w_mod_hh43, . . . , w_mod_hh416]]
Modulated Bias IH (Shape: 16):
[b_mod_ih1, b_mod_ih2, b_mod_ih3, . . . , b_mod_ih16]
Modulated Bias HH (Shape: 16):
[b_mod_hh1, b_mod_hh2, b_mod_hh3, . . . , b_mod_hh16]

Because the extra conditioning dimension modulates the classic parameter dimensions via tensor operations (e.g., matrix multiplication or an Einstein summation) to produce effective, style-conditioned weights and biases, the runtime cost may be understood as having (i) a parameter-generation step and (ii) a sequence-processing step. In some embodiments, for a fixed conditioning embedding, the parameter-generation step may be performed once to compute a set of effective (“collapsed”) weight matrices and bias vectors, and the resulting collapsed parameters may be stored in memory and reused for subsequent inference. Thereafter, applying the base neural network to an input sequence of length T using the stored collapsed parameters may have substantially the same order of computational complexity as the corresponding non-superpositional base network. For example, a classic LSTM may be characterized as O(T*(H\hat{ }2+H*I)) where T is sequence length, H is hidden size, and I is input size, and in such embodiments the per-timestep computation using cached collapsed parameters remains of the same order. When the conditioning embedding changes (e.g., between styles, sessions, or segments), the collapsed parameters may be recomputed and cached again. This arrangement permits training of large, dynamically generalizable superpositional models while deploying, during inference, an efficient “classic” model instance specialized to a given conditioning embedding.

While the embodiments above have been described using the example of a superpositional LSTM, myriad neural networks may be used, including but not limited to CNN, transformer, U-Net, diffusion, etc. For example, some embodiments may include a superpositional transformer as decoder. In some such embodiments, the conditioning embedding may modulate the query, key, and value weights on a per layer basis similarly to how the weights may be modulated using the LSTM, such as by adding an extra dimension that collapses, such as during inference. Also, the weights and biases in the feed-forward network in a superpositional transformer may be similarly dimensioned to the superpositional LSTM. In some embodiments, even the input projection layer may be made superpositional. In some embodiments, the system may then include using an Einstein summation function to compute how the modulated weights may interact with the input data in a classic transformer attention calculation. The feed-forward network's weights and biases may then be handled in the same manner. Additionally, a real-time version of a transformer (such as, for example, a transformer xl) which may have a recurrent memory of previous hidden states and may be causally trained, may also be implemented for real-time rather than post-hoc implementations. These superpositional blocks may be preceded, followed by, or interspersed with traditional selective state and attention blocks in various combinations that those skilled in the art will understand to be task-specific. In some embodiments, the style-conditioned parameters may include normalization parameters (e.g., LayerNorm, RMSNorm, BatchNorm scale and shift parameters) and/or convolution kernels and/or attention projection matrices.

In other embodiments, a superpositional selective state, or Mamba model, may be utilized where some or all of its Mamba selective state sequence layers receive superpositional conditioning via an extra dimension in the weights and/or biases of the input projection tensors, output projection tensors, or any additional combination of superpositional implementation of tensors within any given block where dynamic conditioning may be salutary. These superpositional blocks may be preceded, followed by, or interspersed with traditional selective state and attention blocks in various combinations that those skilled in the art will understand to be task-specific. Further embodiments may be in what are called minGRU or minLSTMs, in which hidden state dependencies may be removed; tanh and sigmoid constraints are removed; and forget and input gates are made to sum to 1. The equations of a minLSTM are no longer strictly time-dependent and so may be computed using a parallel scan algorithm. The superpositional conditioning of weights and biases in a superpositional implementation of a minLSTM remains similar in practice then to the superpositional implementation of a “classic” LSTM outlined above.

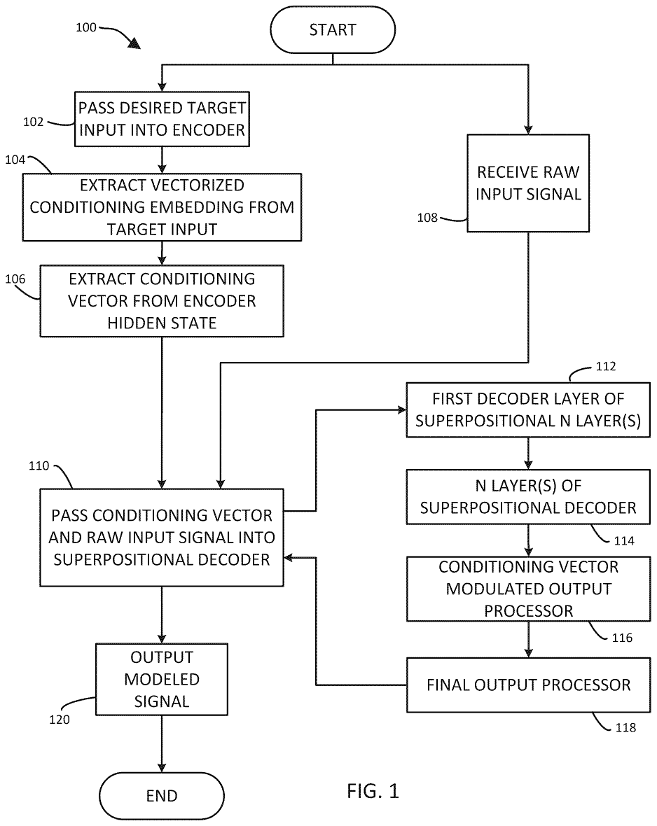

FIG. 1 shows a flow chart representing an embodiment of a method 100 for dynamic neural network conditioning. In some embodiments, the method 100 may include using an encoder-decoder model, in which an encoder may process input data into an encoded format that may be used by the model, and a decoder may transform the encoded data into an output. The encoded format may be a compressed representation of the input (e.g., a compact, numerical representation of the input) that may capture essential features and/or patterns of the input. In some embodiments, the encoder may extract conditioning embeddings from the input. The encoder may be a custom encoder, and may include or be based on a feature encoder, a quantization module, and/or a Transformer (e.g., variational autoencoders, wav2vec2 style models, etc.). In some embodiments, the custom encoder may be pre-trained on large amounts of unlabeled data, such as audio data or other applicable data for the particular application, which may allow the model to represent the raw input signal (e.g., target input such as audio or other applicable input) as a series of latent features. In some embodiments, the custom encoder may be a customized wav2vec2 encoder or any type of model that may produce latent variables or representations (e.g., variational autoencoders, style models, etc.). In some embodiments, the custom encoder may be fine-tuned as an application-specific signal classifier (e.g., electric guitar signal, voice signal, or other applicable signal classifier as described herein) before being used as an encoder.

As described in more detail below, a “thought vector” (i.e., a latent representation prior to a classification layer) may be extracted as a style vector (i.e., conditioning embedding) and passed into a decoder, which may be virtually any type of model (e.g., a superpositional LSTM, CNN, transformer, U-Net, diffusion, etc.). In some embodiments, an x-vector or other discriminatory classification head may be used to generate such style vectors/conditioning embeddings. In some embodiments, for output processing, the vectorized output from the decoder may be fed into a generative model (e.g., WaveNet or other autoregressive models, transformer based sequence models, or diffusion-based generators) for generating a modeled output, such as audio waveforms or other applicable output (e.g., video, voice signal, etc.), in which each residual block may also be modulated by the style vector/conditioning embedding via affine transformations.

In some embodiments, once the model has been trained, the encoder may be trained with different combinations of classification objectives, contrastive loss, discriminator heads, and the resulting intermediate representation (e.g., a latent or embedding) may be reused as a conditioning embedding during inference. The model may be primarily trained on a combination of Energy-to-Signal loss which pertains to the temporal domain and multiresolution STFT loss (short-term Fourier transforms)—which may include phase loss—a temporally-inflected and perceptually-weighted spectral loss function. Some embodiments may use one or more of a variety of loss functions in addition or alternatively to the STFT/energy-to-signal losses described above, including perceptual losses, adversarial losses, contrastive or representation learning objectives, etc. In some embodiments, DC loss may be included to help the signal maintain its overall bias. In some embodiments, L1, L2, and signal-to-noise loss functions may be incorporated. In some embodiments, other loss functions in the temporal, spectral, visual, fractal, and econometric domains may be incorporated.

In some embodiments, the custom encoder may take raw style target signals (e.g., audio waveforms, images, video) as input and then discretize and tokenize the signal to produce a vector/embedding that may represent the unique characteristics of the inputted signal. In some embodiments, this “left half” of the model may not need to run in real-time as it may be responsible for style extraction that may be later applied to a raw input signal. The style vector/conditioning vector may then be passed into the “right half” of the model, the decoder (e.g., LSTM, CNN, transformer, U-Net, diffusion, etc.). In some embodiments, the decoder may use the style vector/conditioning vector to vectorize a raw unmodulated signal in real-time or substantially real-time, which may allow for long temporal and non-linear modeling.

The decoder may pass the resulting transformed and vectorized signal to an output processor, such as a generative model (e.g., WaveNet or other autoregressive models, transformer based sequence models, or diffusion-based generators) for generating the appropriate output corresponding to the input signal (e.g., audio waveforms, images, video, etc.)). In some embodiments, the output processor may also receive transformations via the style/conditioning vector in every residual block. In some embodiments, this implementation of the output processor may be computationally “light” by also modulating the generative model of the output processor via the style/conditioning vector. Traditionally, mapping a decoder output (e.g., an LSTM output) directly to discrete audio samples may be a computational-cum-performance bottleneck. Here, the generative model for the output processor (e.g., for generating audio waveforms) may remain computationally light via affine conditioning. The custom encoder may transform the input into a fixed-size vector or set of vectors that may represent the input, as described in further detail below. Further, in some embodiments, the decoder and output processor may be a chunked streaming multi-tier memory conformer. In one example, the system may include neural codecs (e.g., vocal neural codec) where conditioning latent variables may be extracted and sent via a separate stream, and a “relatively style invariant” content stream (e.g., voice content stream) may be sent across a residual vector quantizer. The separate streams may then be reassembled using the conditioning techniques described herein. In some embodiments, this may reduce the information load on the RVQ (Residual Vector Quantization) module and may enable better compression.

In some embodiments, at 102, the method may include passing a desired style in the form of a target input into an encoder, such as the custom encoder described above. The target input may be virtually any input with a style sought to be replicated, such as a voice recording, music or instrument recording, live sample of a desired tone, image, video, sensor data, other time-series or spatial data, etc. For example, the target input may be an example of a particular effect produced by an electric guitar or other instrument in a song or other recording. In some embodiments, the target input received by the encoder may be a target style signal (e.g., audio waveform) and may be represented as a tensor with a shape [sequence_length], e.g., [2048], based on the sequence length of the target input. In some embodiments, the method may include extracting a conditioning vector from the target input, where the conditioning vector may be a numerical representation of the target input's “style” or other representative features. Extraction of the conditioning vector (or “conditioning embedding”) may take place in two steps:
(1) At 104, the method may include extracting a vectorized embedding from the target input. In some embodiments, the vectorized embedding (i.e., “thought vector”) may be a vector leveraged based on learned representations (e.g., a 768-dimensional vector), and may be extracted via pooled hidden layer extraction, x-vector embedding, etc. In some embodiments, the vectorized embedding may capture “essential” characteristics of the target input that may be determined through processes like short-time analysis, spectral representation, dimensionality reduction, contextual learning, and/or quantization. The custom encoder may output a hidden state that may include the sequence length of the target input and the dimensions of the vectorized embedding as a tensor with shape [sequence_length, 768], e.g., [2048, 768]. In some embodiments, a discriminatory or classification head may be trained as part of the encoder and its vector output used as the conditioning embedding (e.g. an x-vector embedding).
(2) At 106, the method may include extracting a conditioning vector from the hidden state or discriminator/classifier head's embedding outputted from the custom encoder. In some embodiments, this may include using the hidden state from the custom encoder, e.g., tensor with [batch size, hidden dimension], as an input to a linear layer or an implementation of a bottleneck module (expanding and collapsing) to extract a conditioning vector that may have a size, for example, of 256. In such embodiments, the conditioning vector (i.e., conditioning embedding) may be a vector with shape [256]. In some embodiments, a linear layer may be a part of the custom encoder to resize the conditioning vector for input into the superpositional decoder.

At 108, a superpositional decoder may receive a raw input signal to be transformed in the same style as the target input. In some embodiments, the superpositional decoder may include a superpositional LSTM with two layers (i.e., N layers), a conditioning vector modulated output processor, and a final output processor, but the decoder may be other types of models such as CNN, transformer, U-Net, diffusion, etc. The raw input signal may be virtually any signal sought to be amended to replicate the style of the target input, such as an electric guitar signal, other instrumental input, a digital telephone call, a video call, an image, sensor data, etc. In some embodiments, the raw input signal may be a raw audio sequence with a sequence length and an input size that may a tensor with shape [sequence_length, input_size], e.g., [2048, 256]. At 110, the method may include passing the conditioning vector into a superpositional decoder along with the raw input signal. In some embodiments, the superpositional decoder may be a model with two or more layers (i.e., N layers).

At 112, a first decoder layer of the N layers may receive, as a first layer input, the raw input signal with tensor shape [sequence_length, input size] and the conditioning vector with shape [256]. The first decoder layer may, via matrix multiplication, modulate the input-to-hidden weights (W_ih) and hidden-to-hidden weights (W_hh) using the conditioning vector. The first decoder layer may also add style-modulated biases (bias_ih and bias_hh), and may apply decoder (e.g., LSTM or other model) gating mechanisms (e.g., input gate, forget gate, output gate) to process the raw input signal. The first decoder layer may output a hidden state for a second decoder layer of the superpositional decoder as a tensor with shape [sequence_length, hidden_size], e.g., [2048, 256]. At 114, the second decoder layer may receive, as a second layer input, the hidden state output by the first decoder layer. The second decoder layer may be a standard decoder layer, and may use non-modulated weights and biases. The second decoder layer may output a final hidden state and a cell state as a tensor with shape [layer2_sequence_length, layer2_hidden size], e.g., [2048, 256]. In some embodiments, additional N layer inputs may be received for N layers of the superpositional decoder (e.g., superpositional LSTM or other superpositional decoder).

At 116, a conditioning vector modulated output processor may receive the final hidden state from the superpositional decoder; specifically, the second decoder layer output. In some embodiments, the conditioning vector modulated output processor may be a generative model for generating a particular output (e.g., audio waveforms, images, video, etc.), which may predict each sample based on previous samples (e.g., WaveNet or other suitable generative model). The final hidden state may pass through multiple residual blocks, in which: dilated convolutions may capture long-range dependencies, style-based feature modulation (e.g., scale and shift) may be applied to modulate activations based on the conditioning vector, and gated activation may be applied to the modulated features. Additionally, skip connections may aggregate intermediate results. The conditioning vector modulated input may be a tensor with shape [layer2_hidden_size, layer2_sequence_length], e.g., [256, 2048] The conditioning vector modulated output processor may output a final processed output, as a tensor with shape [final_sequence_length, final_hidden_size], e.g., [2048, 256].

At 118, a final output processor may receive the final processed output from the conditioning vector modulated output processor (e.g., WaveNet or other deep generative model). The final output processor may include a final linear layer that may process the final processed output to match a desired output size (e.g., style-conditioned raw audio waveform). At 120, the method may include outputting a modeled signal (e.g., modeled guitar signal, modeled voice signal, modeled image or video signal, etc.) from the superpositional decoder (specifically, the final output processor) as a tensor with shape [output_sequence_length, output_size], e.g., [2048, 1].

In some embodiments, the method for dynamic neural network conditioning may be represented in the following, non-limiting example:

### Encoder

### 1. Custom Encoder (e.g., Wav2Vec2 or VAE, etc.)

Input: Target style signal [sequence_length]
Process: Extracts a “thought vector” (e.g., 768-dimensional) from the target style audio, leveraging learned representations.
Output: Hidden state [sequence_length, 768]

### 2. Conditioning Embedding Extraction

Input: Hidden state from encoder [sequence_length, 768]
Process: Passes the hidden state through a linear layer to extract a conditioning vector of size 256.
Output: Conditioning Vector [256]

### Decoder

### 3. Superpositional Decoder (2 Layers)

a. First Layer:
   Input: Raw input signal (e.g., audio signal) sequence [sequence_length, input_size] and conditioning vector [256]
   Process:
      Modulates via matrix multiplication the input-to-hidden weights (W_ih) and hidden-to-hidden weights (W_hh) using the conditioning vector.
   Adds style-modulated biases (bias_ih and bias_hh).
      Applies decoder gating mechanisms (input, forget, output gates) to process the raw audio sequence.
   Output: Hidden state for the second decoder layer [sequence_length, hidden_size]
b. Second Layer:
   Input: Hidden state from the first decoder layer [sequence_length, hidden_size]
   Process: Standard decoder layer, using non-modulated weights and biases.
   Output: Final hidden state and cell state [sequence_length, hidden_size]

### 4. Conditioning-Vector Modulated Output Processor

Input: Final hidden state from the Superpositional Decoder [hidden_size, sequence_length]
Process:
   Passes through multiple residual blocks, where:
      Dilated convolutions capture long-range dependencies.
         Style-based feature modulation (scale and shift) is applied to modulate activations based on the conditioning vector.
      Gated Activation is applied to the modulated features.
   Skip connections aggregate intermediate results.
Output: Final processed output [hidden_size, sequence_length]

### 5. Final Output

Input: Output from output processor (e.g. WaveNet) [sequence_length, hidden_size]
Process: A final linear layer processes the output to match the desired output size (e.g., style-conditioned raw signal, such as audio waveform).
Output: Modeled output signal (e.g., modeled guitar signal or other modeled signal type) [sequence_length, output_size]

### Example Tensors

Target Style Signal Input (Shape: [sequence_length])
   Example: [2048]
Hidden State Output (Shape: [sequence_length, 768])
   Example: [2048, 768]
Conditioning Vector (Shape: [256])
   Example: [256]
Decoder First Layer Input (Shape: [sequence_length, input_size])
   Example: [2048, 256]
Decoder First Layer Output (Shape: [sequence_length, hidden_size])
   Example: [2048, 256]
Decoder Second Layer Output (Shape: [sequence_length, hidden_size])
   Example: [2048, 256]
Generative Model Input (Shape: [hidden_size, sequence_length])
   Example: [256, 2048]
Generative Model Output (Shape: [sequence_length, hidden_size])
   Example: [2048, 256]
Final Modeled Signal Output (Shape: [sequence_length, output_size])
   Example: [2048, 1].

In some embodiments, a superpositional linear layer may be defined by a weight tensor W of shape [K×M×N] and, optionally, a bias tensor b of shape [K×N]. Given an input activation x in R\hat{ }M and a conditioning embedding s in \hat{ }K, the effective weight may be computed by a weighted combination of the slices of W:

$$W ( s ) = sum\_ \{ k = 1 \} \hat{} Ks\_k * W\_k ,$$

and similarly for the bias. This may be the equivalent to flattening W along the (M, N) dimensions, multiplying by s, and reshaping to obtain a standard [M×N] matrix. In some embodiments, the resulting mapping:

$$x -> y = x * W ( s ) + b ( s )$$

may be used in any part of the model to provide fine grained, sample specific conditioning.

Low Rank-Style Conditioned Linear Layers

In some embodiments, the superpositional weights and biases described herein may be implemented using a low-rank parameterization along the conditioning dimension. For example, let K denote the dimension of the conditioning embedding, let M denote an input feature dimension, and let N denote an output feature dimension. A naïve implementation that stores a separate weight matrix for each possible conditioning component would require a weight tensor of shape (K, M, N), which has K*M*N parameters. Instead, a style-conditioned linear layer may maintain, for example:
a base weight matrix W_base of shape [M×N] that may be independent of the conditioning embedding;
a style projection matrix P of shape [K×R], where R<<K may be a rank or bottleneck dimension; and
a basis weight tensor B of shape [R×M×N] that may store R basis perturbation matrices.

Given a conditioning embedding s in R\hat{ }K, the style projection module may compute a coefficient vector c=s*P (shape [R]). The layer may then compute a style specific perturbation:

$$DeltaW ( s ) = sum\_ \{ r = 1 \} \hat{} Rc\_r * B\_r ,$$

where each B_r has shape [M×N] and is a slice of the basis weight tensor. The effective weight matrix for the given conditioning embedding may be:

$$W ( s ) = W\_base + alpha * DeltaW ( s ) ,$$

where alpha represents an optional scaling factor. A similar construction may be applied to bias vectors. Accordingly, the number of parameters may grow as M*N+K*R+R*M*N, which may represent a substantial reduction relative to K*M*N when R is much smaller than K.

Such an arrangement may be considered a hypernetwork that may map a conditioning embedding s to a weight update DeltaW(s) via a low-rank factorization. In contrast to typical LoRA usage for offline fine tuning, the disclosed style conditioned layer may compute the update dynamically at inference time for each input sample, allowing real-time style transfer, speaker adaptation, task adaptation, etc., depending on the particular input signal and target input.

In some embodiments, the layer may further include a collapsed weight mode. For a fixed conditioning embedding s*, the system may evaluate W(s*) and the corresponding bias vector once and cache the resulting matrices. Subsequent inference steps may then use the cached matrices exactly as a conventional linear layer, without recomputing DeltaW(s*). This may permit deployment of dynamically generated per-style models while preserving the runtime efficiency of static networks.

In some embodiments, the weight matrices and biases in the superpositional decoder (e.g., superpositional LSTM or in other network components such as convolutional layers, attention layers, or multilayer perceptrons) may be implemented using the low rank style conditioned parameterization described herein. For example, the input to hidden and hidden to hidden matrices in one or more decoder (e.g., LSTM) layers may share a base matrix while using different basis tensors and projection matrices for different gates or layers.

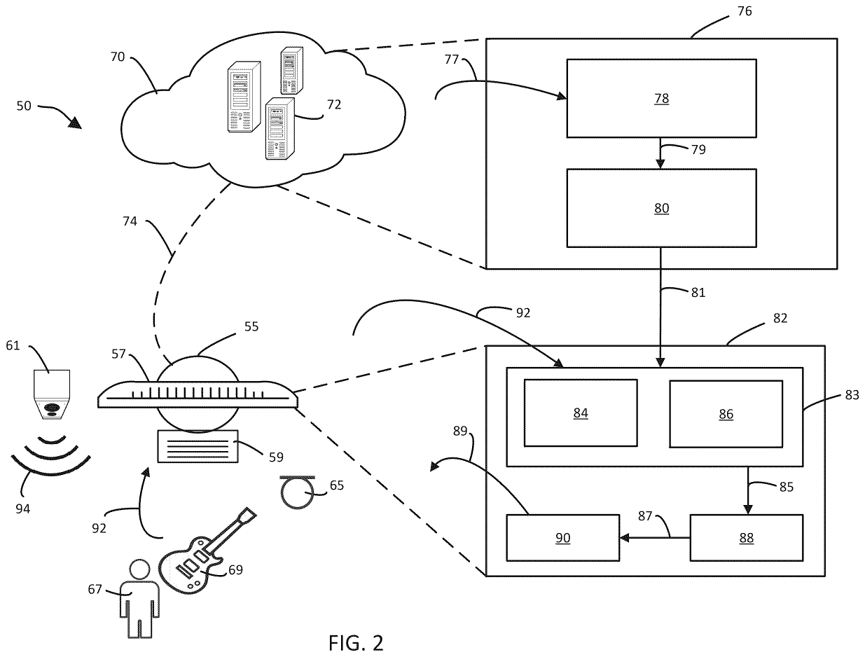

FIG. 2 shows an embodiment of a simplified hardware environment 50 in an embodiment of a system for dynamic neural network conditioning may operate. Such a system may be used to perform the method 100 shown and described with reference to FIG. 1. The environment 50 may include one or more user computers 55 that may be of any suitable type, including desktop, laptop, tablet, mobile phone, virtual reality (VR) or augmented reality (AR) platform, implanted computer technology, etc. The computer 55 may include a monitor 57 for displaying visual output from the computer, and one or more input devices 59 (e.g., mouse, keyboard, etc.). The computer 55 may also be connected to one or more speakers 61 that may output audio from the computer, and which may be built-in or external. The computer 55 may also be connected to one or more microphones 65 or other sensors that may capture audio input or other input (e.g., video, images, other signals, etc.) and transmit the input to the computer, and may be built-in or external. It should be understood that the computer 55 and its various components may be connected via hardwire connections or wireless connections, such as Wi-Fi, Bluetooth, NFC, etc. Other computing environments may have more or fewer components and still be consistent with the disclosure.

The environment 50 may also include a user, such a user 67 that may be using user equipment 69. In some embodiments, such as when the system 50 may be used as a universal guitar signal chain (UGSC), the user equipment 69 may be a guitar. Those skilled in the art will recognize that, in some embodiments, the user equipment may be virtual anything capable of creating or transferring a digital signal, such as a telephone, piano, other musical instrument, etc. In embodiments where a telecommunication signal may be processed by the system, the user equipment 69 and the computer 55 may be one in the same mobile computing device, such as a smart phone or tablet. In some embodiments, the computer 55 itself may act as the user equipment, such as when the signal to be processed may be a signal related to algorithmic trading or other suitable signal. The user equipment may or may not be electronically connected to the computer 55 or its components. For example, in the UGSC, the user equipment 69 (i.e., guitar) may be directly connected to the computer via a cord and/or through an amplifier, or the audio signal may be received via the microphone 65. In some embodiments, the user 67 may have no user equipment at all, such as for embodiments related to speaking, singing, etc., where the audio may be received via the microphone 65. In some embodiments, the microphone 65 may be configured to capture audio in substantially real time and transmit those inputs to the computer 55 for processing or remote transmission.

In some embodiments, one or more components in the environment 50 may be connected (either through hard wires or wirelessly) to a remote computing environment 70. The remote computing environment 70 may include one or more remote servers 72 that may be connected in one or more networks. The remote servers 72 may be disposed in one physical location or may be distributed in various locations electronically connected to one another. In some embodiments, the computer 55 may connect to the remote computing environment 70 via a suitable communication network 74, such as the internet, cellular networks, local networks, etc. In some embodiments, the system for dynamic neural network conditioning may reside on one or more remote servers 72 in the remote computing environment, may reside on the user computer 55, or may reside in a combination of the user computer and the one or more remote servers. Data relating to operating the system may be transmitted between the computer 55 and/or its components and the remote computing environment 70 via one or more streaming protocols or other suitable computer or network data transmission protocols.

In some embodiments, one or more actions of the systems and methods may occur at the computer 55, and one or more actions may occur in the remote computing environment 70. In the example embodiment depicted in FIG. 2, the remote computing environment may run and operate a custom encoder 76 (described in more detail in reference to FIG. 1) using one or more remote servers 72. The custom encoder 76 may include an encoder module 78 and a conditioning embedding extractor module 80. As described with reference to FIG. 1, the encoder module 78 may receive a target input 77 and output a hidden state 79 to the conditioning embedding extractor module 80. In some embodiments, the target input 77 may be received from the computer 55, may originate on the one or more remote servers 72, or may be received from another source via the communication network 74. The conditioning embedding extraction module 80 may receive the hidden state 79 as an input and output a conditioning vector 81. In some embodiments, the one or more remote servers 72 may transmit the conditioning vector 81 to the computer 55 via the communication network 74. Although FIG. 2 shows the custom encoder 76 running and operating on the one or more remote servers in the remote computing environment 70, it should be understood that the custom encoder 76 may run on the computer 55 in some embodiments, or in both the remote computing environment and the computer in yet other embodiments.

In some embodiments, such as depicted in FIG. 2, the computer 55 may include or run a superpositional decoder 82, such as described in more detail with reference to FIG. 1. In some embodiments, the superpositional decoder 82 may include a superpositional decoder module 83 (such as an LSTM, transformer, CNN, diffusion U-Nets, etc.), a conditional-vector modulated output processor 88, and a final output module 90. The superpositional decoder module 83 may include a first decoder layer 84 and a second decoder layer 86, as described in more detail with reference to FIG. 1. The superpositional decoder module 83 may receive a raw input signal 92. In some embodiments, the raw input signal 92 may be received from the user equipment 69, such as when the system is operating as a UGSC and the raw input signal may be a guitar input. The superpositional decoder module 83 may also receive the conditioning vector 81 along with the raw input signal 92 as an input, and may output a final hidden state 85 and a cell state. In some embodiments, the conditioning-vector modulated output processor 88 (as described in more detail with reference to FIG. 1) may receive the final hidden state 85 from the superpositional decoder 83 as an input and may output a final processed output 87. The final output module 90 may receive the final processed output 87 as an input and output a modeled signal 89 (e.g., a modeled guitar signal, modeled voice signal, modeled image or video, etc.). In some embodiments, such as when the system may be operating as a UGSC and/or universal guitar amplifier or other audio signal modeler, the modeled signal 89 may pass through the speakers 61 as a modeled audio output 94.

In some embodiments, the modeled audio output 94 may be a translation of the raw input signal 92 in the style of the target input 77. For example, the user 67 may play one or more notes on the user equipment 69 (e.g., electric guitar, piano, drums, etc.), the system may combine the raw input signal 92 and the target input 77 as described herein, and the computer 55 may play the resulting one or more notes through the speakers 61. In some embodiments, the time lag between the user 67 providing an input with the user equipment 69 and receiving (e.g., hearing) the modeled output 94 (e.g., audio) may be substantially negligible such that the modeled output may be received in substantially real-time as the user is provides the input (e.g., plays the notes, speaks, or provides other signal). In some embodiments, the custom encoding process, such as may occur via custom encoder 76, may occur prior to the user 67 providing an input via the user equipment 69 such that the conditioning vector 81 may have already been extracted from the target input 77 before the computer 55 receives the raw input signal 92. Such pre-processing of the target input 77 may, in some embodiments, provide for faster processing of the raw input signal 92 into the modeled output 94. It is contemplated, however, that in some embodiments, the target input 77 may be received by the custom encoder 76 in substantially real time with the raw input signal 92 while still providing the modeled output 94 in real time or substantially real time. Although FIG. 2 shows certain operations being performed by the one or more remote servers in the remote computing environment 70 and other operations being performed by the computer 55, it should be understood that each operations descried with reference to FIG. 2 (and more generally herein) may be performed in the remote server environment 70 in some embodiments, by the computer 55 in some embodiments, and/or in both the remote computing environment and the computer in yet other embodiments.

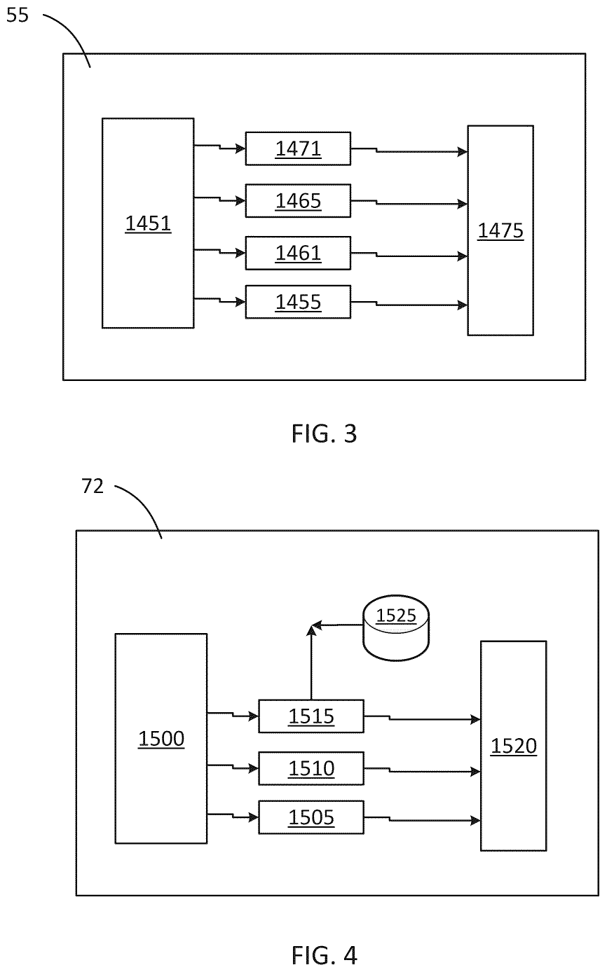

FIG. 3 is a simplified illustration of some physical elements that may make up an embodiment of a computing device, such as the computing device 55, and FIG. 4 is a simplified illustration of the physical elements that make up an embodiment of a server type computing device, such as may be used for the one more remote servers 72. Referring to FIG. 3, a sample computing device is illustrated that is physically configured to be part of the systems and method for dynamic neural network conditioning. The computing device 55 may have a processor 1451 that is physically configured according to computer executable instructions. In some embodiments, the processor may be specially designed or configured to optimize communication between a server relating to the system described herein. The computing device 55 may have a portable power supply 1455 such as a battery, which may be rechargeable. It may also have a sound and video module 1461 which assists in displaying video and sound and may turn off when not in use to conserve power and battery life. The computing device 55 may also have volatile memory 1465 and non-volatile memory 1471. The computing device 55 may have GPS capabilities that may be a separate circuit or may be part of the processor 1451. There also may be an input/output bus 1475 that shuttles data to and from the various user input/output devices such as a microphone, a camera, a display, or other input/output devices. The computing device 55 also may control communicating with networks either through wireless or wired devices. Of course, this is just one embodiment of a computing device 55 and the number and types of computing devices 55 is limited only by the imagination.

The physical elements that make up an embodiment of a server, remote server 72, are further illustrated in FIG. 4. In some embodiments, the server 72 may be specially configured to run the system and methods for dynamic neural network conditioning as disclosed herein. At a high level, the server 72 may include a digital storage such as a magnetic disk, an optical disk, flash storage, non-volatile storage, etc. Structured data may be stored in the digital storage a database. More specifically, the server 72 may have a processor 1500 that is physically configured according to computer executable instructions. In some embodiments, the processor 1500 can be specially designed or configured to optimize communication between a computing device, such as user computer 55, and A/V equipment or remote cloud server 72 as described herein. The server 72 may also have a sound and video module 1505 which assists in displaying video and sound and may turn off when not in use to conserve power and battery life. The server 72 may also have volatile memory 1510 and non-volatile memory 1515.

A database 1525 for digitally storing structured data may be stored in the memory 1510 or 1515 or may be separate. The database 1525 may also be part of a cloud of servers and may be stored in a distributed manner across a plurality of servers. There also may be an input/output bus 1520 that shuttles data to and from the various user input devices such as a microphone, a camera, a display monitor or screen, etc. The input/output bus 1520 also may control communicating with networks either through wireless or wired devices. In some embodiments, an immersive experience controller for running an immersive experience API may be located on the computing device 55. However, in other embodiments, the immersive experience controller may be located on server 72, or both the computing device 55 and the server 72. Of course, this is just one embodiment of the server 72 and additional types of servers are contemplated herein.

While FIG. 2 depicts an embodiment in which the system and methods for dynamic neural network conditioning may be implemented to provide a universal guitar signal chain (i.e., universal guitar amplifier), those skilled in the art will understand that the systems and methods described herein may be implemented in other contexts for signal conditioning, such as (but not limited to) telecommunications, spoken voice, images and video, sensor data, etc.. For example, the system may be used for enhancing voice and data transmission quality for telephone calls, making it possible to maintain high fidelity even in challenging environments such as low-bandwidth or noisy channels. The system and methods may also allow for performing real-time conditioning on mobile devices (such as for audio and/or video) without relying on cloud computing, which may vastly increase user experience in applications like video conferencing, gaming, and augmented reality, etc., where latency and signal quality may be important. In the music and entertainment industry, the systems and methods may allow for development of affordable and highly customizable audio equipment, allowing musicians and producers to achieve professional-grade sound processing with minimal hardware investment. Further, the computational efficiency of the superpositional decoder described herein may enable integration into a wide range of consumer electronics, including (but not limited to) smart speakers and automotive infotainment systems, and may provide adaptive audio experiences tailored to individual user preferences.

Additionally, while the disclosure describes a superpositional decoder in the context of conditioning raw input signals based on the “style” of another input (i.e., style input or target input), the systems and methods for dynamic neural network conditioning, and specifically the superpositional decoder, may operate using vectors other than “style vectors.” In other words, in some embodiments, the vector input may be virtually any type of input, including human feedback. Such embodiments may provide “guided training of models,” for example, where a human operator may provide dynamic, differentiable input into the training cycle without violating the training itself. For example, in the context of a guitar amplifiers (such as described herein), a user may provide live feedback into the training to get a guitar amp sound as desired, such as “take off some treble...dial back the gain . . . ” etc. Further, in some embodiments, the system may provide for developing a specific model of amplifier with specific sounds, as opposed to a “universal” amplifier.

In some embodiments, the systems and methods for dynamic neural network conditioning may be used to add “tooling” to generative AI models or systems. Traditionally, one weakness of many generative AI systems is its imprecision and “uneditability,” also known as “one-shot” generation. The systems and methods described herein may provide a model that may allow human input that may provide persistent control over any artifacts generated by the AI model. In other words, the systems may provide for using vectorized human feedback as conditioning vectors that may help a meta-generative model factorize the latent space representations—using adversarial loss that penalizes the decoder if changes to one dimension (e.g., lighting) affect other dimensions (e.g., texture). Such embodiments of the system may provide a user interface via the superpositional decoder that may allow for models that may be more flexible and capable of specific (or general/global) adjustments, for example, if latent representations are kept “alive” after the initial decoding. This may allow for iterative work on the same latent space with a decoder that may be built on the fly to hone in on specific layers in its own internal architecture in response to human feedback.

### EXAMPLES

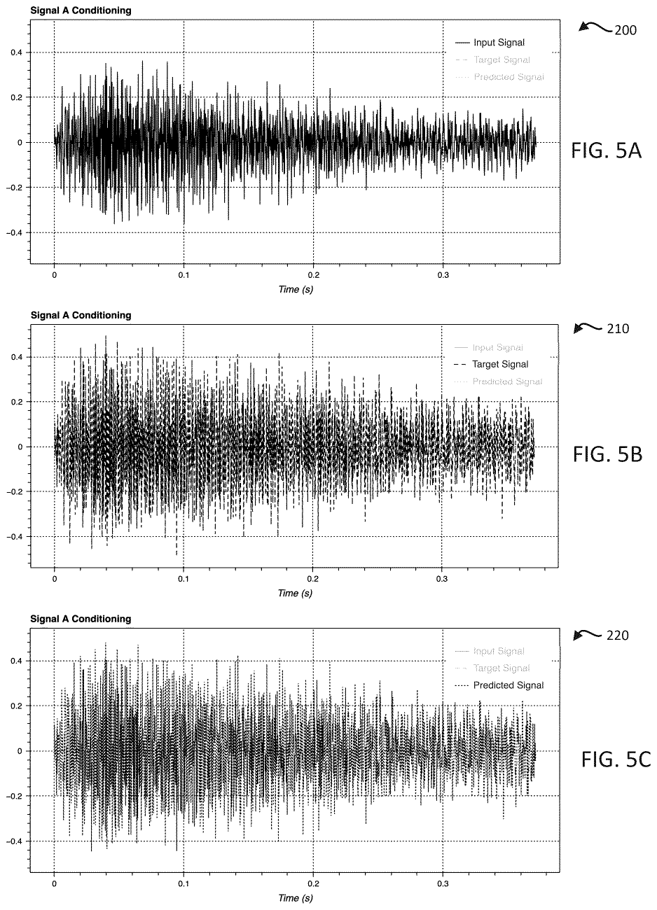

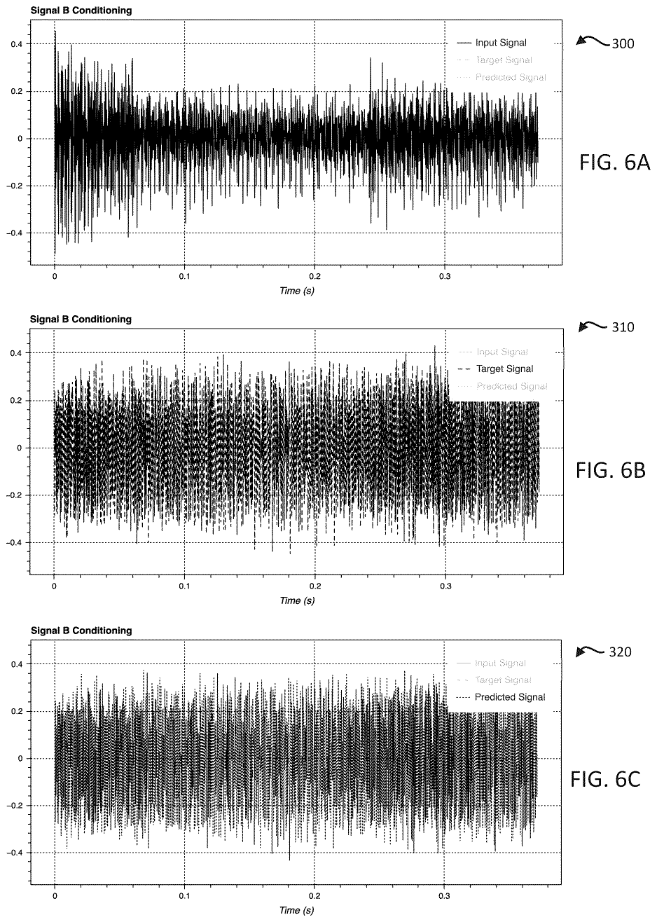

FIGS. 5A-5C and FIGS. 6A-6C show examples of waveforms representing input signals, target signals (i.e., target input), and predicted signal (i.e., output signal) of an embodiment of the system for dynamic neural network conditioning described herein. Specifically, the example waveforms represent an embodiment of using the system as a universal guitar signal chain emulator, receiving raw electric guitar input and transforming it based on a conditioning vector as described herein. Each waveform shows a window of 2048 samples at a 44.1 khz sampling rate, which covers about 46 milliseconds of four different signal chains. Each example includes a raw input signal 200, 300, a target signal 210, 310, and a predicted signal 220, 320 that may be the modeled output. As shown in each example, each waveform representing the predicted signal 220, 320 (i.e., model output) conforms much more closely to the target signal waveform 210, 310 than does each respective input signal waveform 200, 300. This indicates that the input signal waveform 200, 300 has been transformed into the “style” of the target signal 210, 310. In other words, these figures demonstrate the viability of the system to receive a raw input signal 200, 300 as an unmodified signal (e.g., electric guitar signal) and the predicted signal 220, 320 (i.e., model output) is the model's digital prediction of the captured “target” signal chain's desired style (achieved by conditioning the raw input signal with the target signal per the methodology of the invention disclosed herein).

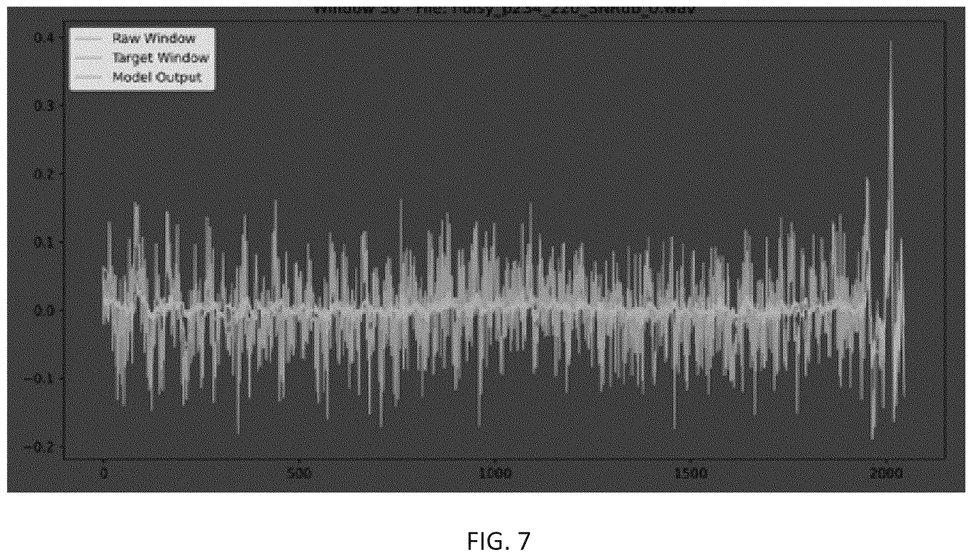

FIG. 7 shows an example of waveforms representing inputs, outputs, and targets for an embodiment of the system operating as a general de-noiser/super-resolution “upsampler,” such as for improving the quality of telephone calls, particularly when reception may be poor and/or available bandwidth is low or attenuated and therefore sound quality may be low. In the example in FIG. 7, the raw window waveform was downsampled to 2.4 khz, which is a severely degraded sound quality (e.g., toy walkie-talkies). As shown, the model output waveform conforms much more closely to the target window waveform than the raw window. The system that provided the results of FIG. 7 used essentially the same architecture as the universal guitar signal chain emulator (FIGS. 5A-5C and 6A-6C) but with reduced/adjusted hyperparameter sizes to account for differing domain space as well as a different blend of loss functions as disclosed previously.

The figures depict preferred embodiments for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer-implemented method of dynamically conditioning a neural network, the method comprising:
receiving, by one or more processors, a target signal;
processing, by the one or more processors, the target signal with an encoder to obtain a conditioning embedding based on the target signal;
receiving, by the one or more processors, an input signal to be processed;
based on the conditioning embedding and a set of learned parameters, computing, by the one or more processors, one or more style-conditioned parameters for one or more layers of a base neural network; and
applying, by the one or more processors, the base neural network to the input signal using the style-conditioned parameters to generate a modeled output signal.

2. The method of claim 1, wherein the one or more style-conditioned parameters include one or more of: (i) a bias vector, (ii) one or more scale parameters or shift parameters associated with a normalization operation, (iii) one or more attention-projection weight matrices, or (iv) one or more convolution kernels.

3. The method of claim 1, wherein the style-conditioned parameters include at least one weight matrix that depends on the conditioning embedding.

4. The method of claim 3, wherein computing the at least one weight matrix that depends on the conditioning embedding includes:
computing an effective weight matrix by combining slices of a weight tensor along a conditioning dimension using the conditioning embedding; and
computing an effective bias vector by combining slices of a bias tensor along the conditioning dimension using the conditioning embedding.

5. The method of claim 1, wherein the style-conditioned parameters for each layer of the one or more layers of the base neural network include:
a base weight matrix; and
a weight update combined with the base weight matrix to produce an effective style-conditioned weight matrix.

6. The method of claim 5, wherein the weight update is a low-rank update determined by the conditioning embedding.

7. The method of claim 6, wherein computing the low-rank update for a given layer includes:
multiplying a first learned matrix with the conditioning embedding to obtain a bottleneck representation; and
multiplying the bottleneck representation by a second learned matrix to obtain the low rank update.

8. The method of claim 5 further comprising, for the conditioning embedding:
computing and storing corresponding style-conditioned weight matrices; and
applying the base neural network using the stored style-conditioned weight matrices without recomputing the weight update.

9. The method of claim 1 further comprising:
generating a conditioning latent stream comprising at least one of the conditioning embedding or conditioning latents;
generating a content latent stream comprising content latents;
quantizing the content latents using residual vector quantization to produce quantized content codes; and
generating the modeled output signal by decoding the quantized content codes conditioned on the conditioning embedding.

10. A non-transitory computer-readable storage medium containing instructions that, when executed by one or more processors, cause the one or more processors to:
receive a target signal;
process the target signal with an encoder to obtain a conditioning embedding based on the target signal;
receive an input signal to be processed;
based on the conditioning embedding and a set of learned parameters, compute one or more style-conditioned parameters for one or more layers of a base neural network; and
apply the base neural network to the input signal using the style-conditioned parameters to generate a modeled output signal.

11. The non-transitory computer-readable storage medium of claim 10, wherein the one or more style-conditioned parameters include one or more of: (i) a bias vector, (ii) one or more scale parameters or shift parameters associated with a normalization operation, (iii) one or more attention-projection weight matrices, or (iv) one or more convolution kernels.

12. The non-transitory computer-readable storage medium of claim 10, wherein the style-conditioned parameters include at least one weight matrix that depends on the conditioning embedding.

13. The non-transitory computer-readable storage medium of claim 12, wherein computing the at least one weight matrix that depends on the conditioning embedding includes:
computing an effective weight matrix by combining slices of a weight tensor along a conditioning dimension using the conditioning embedding; and
computing an effective bias vector by combining slices of a bias tensor along the conditioning dimension using the conditioning embedding.

14. The non-transitory computer-readable storage medium of claim 10, wherein the style-conditioned parameters for each layer of the one or more layers of the base neural network include:
a base weight matrix; and
a weight update combined with the base weight matrix to produce an effective style-conditioned weight matrix.

15. The non-transitory computer-readable storage medium of claim 14, wherein the weight update is a low-rank update determined by the conditioning embedding.

16. The non-transitory computer-readable storage medium of claim 15, wherein computing the low-rank update for a given layer includes:
multiplying a first learned matrix with the conditioning embedding to obtain a bottleneck representation; and
multiplying the bottleneck representation by a second learned matrix to obtain the low rank update.

17. The non-transitory computer-readable storage medium of claim 10 further containing instructions that, when executed by one or more processors, cause the one or more processors to:
generate a conditioning latent stream comprising at least one of the conditioning embedding or conditioning latents;
generate a content latent stream comprising content latents;
quantize the content latents using residual vector quantization to produce quantized content codes; and
generate the modeled output signal by decoding the quantized content codes conditioned on the conditioning embedding.

18. The system of claim 10, wherein the system further comprises an input device, and wherein the input signal to be processed is received from the input device by the computing device.

19. A system for dynamically conditioning a neural network, the system comprising:
one or more dynamic conditioning servers connected to a communications network, the one or more servers including one or more server processors and a server memory containing processor-executable instructions that, when executed by the one or more server processors, cause the one or more dynamic conditioning servers to:
receive a target signal, and
process the target signal with an encoder to obtain a conditioning embedding based on the target signal; and
a computing device in communication with the one or more dynamic conditioning servers via the communications network, the computing device including one or more device processors and a device memory containing processor-executable instructions that, when executed by the one or more device processors, cause the computing device to:
receive the conditioning embedding from the one or more servers via the communication network;
receive an input signal to be processed;
based on the conditioning embedding and a set of learned parameters, compute one or more style-conditioned parameters for one or more layers of a base neural network; and
apply the base neural network to the input signal using the style-conditioned parameters to generate a modeled output signal.

20. The system of claim 19, wherein the one or more style-conditioned parameters include one or more of: (i) a bias vector, (ii) one or more scale parameters or shift parameters associated with a normalization operation, (iii) one or more attention-projection weight matrices, or (iv) one or more convolution kernels.
